(19) United States
(12) Patent Application Publication
(10) Pub. No.: US 2026/0058305 A1
(43) Pub. Date: Feb. 26, 2026

(54) LITHIUM-ION BATTERY WITH ELECTRODE CERAMIC COATING

(71) Applicant: TECHTRONIC CORDLESS GP, Anderson, SC (US)

(72) Inventors: Jia Yong LI, Dongguan City (CN); Denis Gaston FAUTEUX, Hong Kong (CN); Xi Qing WANG, Dongguan City (CN); Zhi Qing HAN, Dongguan City (CN)

(21) Appl. No.: 19/103,711

(22) PCT Filed: Dec. 16, 2022
(86) PCT No.: PCT/CN2022/139781

§ 371 Date: Feb. 13, 2025

(30) Foreign Application Priority Data
Aug. 19, 2022 (WO) PCT/CN2022/113763

(51) Int. Cl. H01M 50/434; H01M 4/02; H01M 4/131; H01M 4/133; H01M 4/62; H01M 10/0525; H01M 10/42; H01M 50/403; H01M 50/417; H01M 50/426; H01M 50/443; H01M 50/446; H01M 50/46; H01M 50/489

(52) U.S. Cl. CPC H01M 50/434; H01M 4/131; H01M 4/133; H01M 4/625; H01M 10/0525; H01M 10/4235; H01M 50/403; H01M 50/417; H01M 50/426; H01M 50/443; H01M 50/446; H01M 50/46; H01M 50/489; H01M 2004/021; H01M 2004/027; H01M 2004/028

(57) ABSTRACT

The present invention provides an electrode ceramic coating comprising a ceramic powder and a binder, wherein the thickness of the ceramic coating is 6 μm-9 μm, preferably 7 μm-9 μm, more preferably 8 μm-9 μm. The present invention further provides an lithium-ion battery comprising a cathode electrode, an anode electrode, electrolyte and a housing, wherein the cathode electrode includes a cathode collector and a cathode active material coated thereon, the anode electrode includes an anode collector and an anode active material coated thereon, and wherein the cathode electrode and the anode electrode face each other, and at least one of surfaces of the cathode electrode and the anode electrode that face each other has a ceramic coating. The ceramic coating can replace the battery separator membrane in the conventional sense, and can improve the cycle life and the thermal stability of the lithium-ion battery.

### TECHNICAL FIELD

The present invention relates to the field of batteries, in particular to a lithium-ion battery with the electrode ceramic coating.

### BACKGROUND ART

With the advancement of information, materials and energy technology, lithium-ion batteries have become a hot spot in the research of new power technology due to their high specific energy, long cycle life, no memory effect, safety and reliability, and fast charge and discharge. In addition to being widely used in mobile phones, laptops and other digital electronic products well-known in daily life, the development of electric vehicles will also drive increasing demands for lithium-ion batteries. Moreover, lithium-ion batteries have also been applied in aerospace, navigation, artificial satellites, small medical devices, military communication equipment and other fields, gradually replacing traditional batteries.

A lithium-ion battery usually includes four parts: a housing, electrodes, a separator membrane and electrolyte. The separator membrane refers to the polymer film between the cathode electrode and the anode electrode of the lithium-ion battery. It is the most critical part of the lithium-ion battery and has a direct impact on the safety and cost of the battery. The main functions of the separator membrane are: to isolate the cathode electrode and the anode electrode and prevent the electrons in the battery from passing freely; and to allow the lithium ions in the electrolyte to freely pass between the cathode electrode and the anode electrode. The lithium ion conductivity is directly related to the overall performance of the lithium-ion battery. The isolation between the cathode electrode and the anode electrode by the battery separator membrane enables the battery to limit the current increase in the case of overcharging or temperature rise, preventing the battery from short-circuiting and causing explosion, which plays a role in protecting the safety of users and equipment. Generally, the materials for battery separator membranes are organic polymer materials. These materials are easy to heat up under short circuit or other abnormal conditions of batteries, resulting in melting or even carbonization of organic materials, which will eventually cause the cathode electrode and the anode electrode to contact and short-circuit or even explode. In addition, in order to limit the passage of electrons inside the lithium-ion battery, the separator membrane will increase the internal resistance of the lithium-ion battery, and with the aging of the separator membrane, the internal leakage current of the lithium-ion battery also increases significantly, resulting in a limited cycle life of the lithium-ion battery.

In addition, lithium-ion batteries without tabs have many advantages such as low internal impedance, simple structure and easy processing, and have broad application prospects. However, when an internal short circuit occurs in the lithium-ion batteries with low impedance and no need to weld tabs, a large short-circuit current will be generated, which will easily cause thermal runaway and safety accidents.

On this basis, there is a need to provide a lithium-ion battery with the electrode ceramic coating to at least partially solve the above problems.

### SUMMARY OF THE INVENTION

An object of the present invention is to provide a lithium-ion battery with the electrode ceramic coating, wherein the ceramic coating with a specific thickness formed on an electrode can replace the battery separator membrane in the conventional sense, and the electrode with the ceramic coating can be directly assembled into a battery without the presence of the separator membrane, preventing the direct short circuit between the cathode electrode and the anode electrode caused by the melting of the separator membrane under the condition of short circuit and thermal failure, etc., which will otherwise causes more serious safety hazards. Thus, the safety performance of the battery is increased. Furthermore, the cycle life and the thermal stability of the lithium-ion battery can be improved by using the electrode coating instead of the battery separator membrane. The volumetric specific energy of the battery can be increased by reducing the thickness of the ceramic coating. Furthermore, on the basis of ensuring the safety performance, the design of the lithium-ion battery without tabs is more feasible.

In one aspect, the present invention provides an electrode ceramic coating comprising a ceramic powder and a binder, wherein the thickness of the ceramic coating is 6 μm-9 μm, preferably 7 μm-9 μm, more preferably 8 μm-9 μm.

In one embodiment of the present invention, the material of the ceramic powder is selected from one or more of boehmite, alumina, silica, zirconia, zeolite, magnesia, titanium oxide and barium titanate, preferably boehmite and alumina, more preferably boehmite.

In one embodiment of the present invention, the binder is selected from one or more of PVDF, CMC and SBR, preferably PVDF.

In one embodiment of the present invention, the mass ratio of the ceramic powder to the binder in the ceramic coating is (80-95):(5-20), preferably (80-90):(10-20), more preferably 85:15.

In one embodiment of the present invention, the pore volume of the ceramic coating is 280 uL/mL-320 uL/mL, preferably 289 uL/mL-316 uL/mL, more preferably 315.7 uL/mL.

In one embodiment of the present invention, the ceramic coating further includes an additive, wherein the additive is selected from one or two of PE and PP.

In one embodiment of the present invention, the ceramic coating is obtained by coating a ceramic slurry on the electrode surface to form a coating layer, and drying the coating layer.

In another aspect, the present invention provides an lithium-ion battery comprising a cathode electrode, an anode electrode, electrolyte and a housing, wherein the cathode electrode includes a cathode collector and a cathode active material coated thereon, the anode electrode includes an anode collector and an anode active material coated thereon, and wherein the cathode electrode and the anode electrode face each other, and at least one of surfaces of the cathode electrode and the anode electrode that face each other has the above electrode ceramic coating.

In one embodiment of the present invention, the cathode active material is selected from one or more of lithium nickel cobalt manganate (NCM), lithium cobaltate, lithium nickelate, lithium manganate (LMO), lithium nickel cobalt aluminate, and lithium iron phosphate, preferably lithium nickel cobalt manganate (NCM), and wherein the cathode collector is aluminum foil.

In one embodiment of the present invention, the anode active material is selected from one or more of graphite (C), soft carbon, hard carbon, silicon-carbon composite, elemental silicon and SiOₓ, preferably graphite (C), and wherein the anode collector is copper foil.

In one embodiment of the present invention, the cathode electrode and/or the anode electrode further include a conductive agent, and the conductive agent can be selected from one or more of conductive carbon black, superconductive carbon black (SP), conductive carbon nanotube, conductive fiber and graphites, preferably conductive carbon black, more preferably superconductive carbon black (SP).

In one embodiment of the present invention, the electrolyte is an organic electrolyte, non-aqueous electrolyte, organic solid electrolyte or inorganic solid electrolyte.

In one embodiment of the present invention, the lithium-ion battery does not comprise a separator membrane.

In one embodiment of the present invention, the lithium-ion battery does not comprise a tab.

In one embodiment of the present invention, the cathode active material has a press density of 2.5 g/cc-4.0 g/cc, preferably 3.0 g/cc-3.5 g/cc, more preferably 3.4 g/cc.

In one embodiment of the present invention, the anode active material has a press density of 0.5 g/cc-2.0 g/cc, preferably 1.0 g/cc-1.5 g/cc, more preferably 1.4 g/cc.

In another aspect, the present invention provides the use of an electrode ceramic coating for extending the cycle life of a lithium-ion battery.

In another aspect, the present invention provides the use of an electrode ceramic coating for reducing the average capacity (Ah) degradation of a lithium-ion battery after multiple cycles.

In another aspect, the present invention provides the use of an electrode ceramic coating for retaining the average capacity efficiency (%) of a lithium-ion battery after multiple cycles.

In one embodiment of the present invention, the number of cycles of the lithium-ion battery is ≥400, preferably ≥500, more preferably ≥600.

In one embodiment of the present invention, the number of cycles of the lithium-ion battery is ≥400, preferably ≥500, more preferably ≥600, and the average capacity efficiency (%) retains≥70%, preferably ≥75%, more preferably ≥80%.

In another aspect, the present invention provides the use of an electrode ceramic coating for improving the thermal stability of a lithium-ion battery under a high temperature.

In one embodiment of the present invention, the high temperature is 130° C. or higher.

In another aspect, the present invention provides the use of an electrode ceramic coating for reducing the contact angle of an electrode surface of a lithium-ion battery.

### BRIEF DESCRIPTION OF THE DRAWINGS

FIG. 1 shows the contact angles of different electrode surfaces;

FIG. 2 shows the charge-discharge curves of a full cell with a ceramic coating and a full cell with a separator membrane;

FIG. 3 shows the cycle life curves (Ah, +6C/-6C) of a full cell with a ceramic coating and a full cell with a separator membrane;

FIG. 4 shows the cycle life curves (%, +6C/-6C) of a full cell with a ceramic coating and a full cell with a separator membrane;

FIG. 5 shows the cycle life curves (Ah, +1C/-1C) of a full cell with a ceramic coating and a full cell with a separator membrane;

FIG. 6 shows the cycle life curves (%, +1C/-1C) of a full cell with a ceramic coating and a full cell with a separator membrane;

FIG. 7 shows the curves of heating test of a full cell with a ceramic coating and a full cell with a separator membrane.

### DETAILED DESCRIPTION OF EMBODIMENTS

Referring now to the accompanying drawings, specific embodiments of the present invention will be described in detail. What described herein is only the preferred embodiments of the present invention, and those skilled in the art can think of other ways to realize the present invention on the basis of these preferred embodiments, and the other ways also fall within the scope of the present invention.

The lithium-ion battery comprises a housing, and a cathode electrode, an anode electrode and electrolyte received in the housing, wherein the cathode electrode and the anode electrode face each other, and at least one of surfaces of the cathode electrode and the anode electrode that face each other has a ceramic coating, and wherein the cathode electrode, the anode electrode and the ceramic coating formed on at least one of surfaces of the cathode electrode and the anode electrode that face each other may be assembled into an electrode assembly.

Moreover, the lithium-ion battery further comprises a cap assembly for sealing the housing.

The cathode electrode is, for example, in the form of a plate. The cathode electrode may include, for example, a cathode collector and a cathode material. The cathode collector may have, for example, a thickness of 5 μm to 50 μm. The interval ranges defined in the present invention all include endpoint values. The collector refers to a fine electron conductor that is chemically inert for continuously sending a flow of current to the electrode during discharge or charging. The collector may be used in the form of a foil, a plate, mesh, or the like.

However, the form is not particularly limited as long as the form is in accordance with the purpose. Preferably, the collector is in the form of a foil. Examples of the collector include aluminum foil, aluminum mesh, punched aluminum sheet, aluminum expansion sheet, stainless steel foil, stainless steel mesh, punched stainless steel sheet, stainless steel expansion sheet, foamed nickel, nickel nonwoven fabric, copper foil, copper mesh, punched copper sheet, copper expansion sheet, titanium foil, titanium mesh, carbon nonwoven fabric, and carbon woven fabric, etc. Preferably, the collector is in the form of aluminum foil.

The cathode material is formed on the surface of the cathode collector. The cathode material may be formed only on one side of the cathode collector. The cathode material may be formed on both the sides of the cathode collector. The cathode material may have, for example, a thickness of 10 μm to 200 μm.

The cathode material may include, for example, a cathode active material. The cathode material may consist essentially only of the cathode active material. The cathode material may include optional components. The cathode active material may include, for example, at least one selected from lithium cobaltate, lithium nickelate, lithium manganate (LMO), lithium nickel cobalt manganate (NCM), lithium nickel cobalt aluminate, and lithium iron phosphate.

In addition to the cathode active material, the cathode material may further include a conductive agent. The conductive agent may include optional components. The conductive agent may be selected from one or more of conductive carbon black, superconductive carbon black (SP), conductive carbon nanotube, conductive fiber and graphites. Preferably, the conductive agent is conductive carbon black. More preferably, the conductive agent is SP. Based on 100 parts by weight of the cathode material, the compounding amount of the conductive agent may be, for example, 0.1 parts by weight to 10 parts by weight, preferably 3 parts by weight.

The cathode material may further include a binder. The binder binds the solids to each other. The binder may include optional components. Examples of the binder are polyvinylidene difluoride (PVDF), carboxymethylcellulose (CMC), styrene butadiene rubber (SBR), polybenzimidazole, polyimide, polyvinylacetate, polyacrylonitrile, polyvinylalcohol, starch, hydroxypropyl methyl cellulose, regenerated cellulose, polyvinylpyrrolidone, polyethylene, polypropylene, polystyrene, polymethylmethacrylate, polyaniline, acrylonitrile-butadiene-styrene, phenol resin, epoxy resin, polyethylene terephthalate, polytetrafluoroethylene, polyphenylsulfide, polyamideimide, polyetherimide, polyethylenesulfone, polyacetal, polyphenyleneoxide, polybutylene terephthalate, ethylene-propylene-diene terpolymer (EPDM), sulfonated EPDM, fluoride rubber and various copolymers. Preferably, the binder is selected from one or more of PVDF, CMC and SBR. As a preferred, non-limiting example, the binder is PVDF. Based on 100 parts by weight of the cathode material, the compounding amount of the binder may be, for example, 0.1 parts by weight to 10 parts by weight, preferably 1 part by weight.

In addition, the cathode material may further include other additives, such as lithium carbonate (Li₂CO₃).

In one preferred embodiment of the present invention, the cathode electrode includes a cathode collector made of aluminum foil and a cathode active material layer, wherein the cathode active material layer comprises a cathode active material coated on both surfaces of the cathode collector as a main component.

The cathode active material may be selected from one or more of lithium cobaltate, lithium nickelate, LMO, NCM, lithium nickel cobalt aluminate, and lithium iron phosphate. Cathode uncoated parts are respectively formed at both ends of the cathode collector. The cathode uncoated parts are regions on one or both surfaces of the cathode where the cathode active material layer is not formed. A cathode tab is provided on the cathode uncoated part. An insulation tape is wound on a part of the cathode tab that extends from the electrode assembly to prevent an electrical short. The cathode tab is electrically connected to the cap assembly.

In one further preferred embodiment of the present invention, the cathode electrode does not include a cathode tab, but uses the uncoated part of the cathode collector to be electrically connected to the cap assembly directly.

Furthermore, the cathode material may be formed by coating a slurry containing a solvent. Examples of the solvent are N-methyl pyrrolidone (NMP), cyclohexanone, water, toluene and xylene, but the present disclosure is not limited thereto. Preferably, the solvent used for the cathode material is NMP. The amount of the solvent may be, for example, about 10-500 parts by weight based on the total weight of the cathode material. When the amount of the solvent is within the range above, the active material layer can be easily formed, and preferably, the amount of the solvent is 40-60 parts by weight based on the total weight of the cathode material.

The anode electrode is, for example, in the form of a plate. The anode electrode may include, for example, an anode collector and an anode material. The anode collector may have, for example, a thickness of 5 μm to 50 μm. Preferably, the anode collector is copper foil.

The anode material is formed on the surface of the anode collector. The anode material may be formed only on one side of the anode collector. The anode material may be formed on both the sides of the anode collector. The anode material may have, for example, a thickness of 10 μm to 200 μm.

The anode material may include, for example, an anode active material. The anode material may consist essentially only of the anode active material. The anode active material is selected from one or more of graphite (C), soft carbon, hard carbon, silicon-carbon composite, elemental silicon and SiOₓ, preferably graphite (C).

In one preferred embodiment of the present invention, the anode electrode includes an anode collector made of copper foil and an anode active material layer, wherein the anode active material layer comprises an anode active material coated on both surfaces of the anode collector as a main component. The anode active material is selected from one or more of graphite (C), soft carbon, hard carbon, silicon-carbon composite, elemental silicon and SiOₓ. Anode uncoated parts are respectively formed at both ends of the anode collector. The anode uncoated parts are regions on one or both surfaces of the cathode where the anode active material layer is not formed. An anode tab is provided on the anode uncoated part. An insulation tape is wound on a part of the anode tab that extends from the electrode assembly to prevent an electrical short. The anode tab is electrically connected to bottom of the housing.

In one further preferred embodiment of the present invention, the anode electrode does not include a anode tab, but uses the uncoated part of the anode collector to be electrically connected to bottom of the housing directly.

In addition, the conductive agent and/or the solvent may be optionally included in the anode active material composition and may be the same (or substantially the same) as those described with respect to the cathode material composition, and will not be described in detail herein.

The ceramic coating layer is formed by coating a ceramic slurry made by mixing the ceramic powder, the binder and the solvent onto at least one of the surfaces of the cathode and the anode that face each other. For example, in the jelly-roll type electrode assembly formed by stacking and winding two electrodes, the ceramic coating layer may be formed on at least one of surfaces of the cathode and the anode that face each other, i) by forming the ceramic coating layer on each outer surface of the two electrodes, or ii) by forming the ceramic coating layer on each inner surface of the two electrodes, or iii) by forming the ceramic coating layer on both inner and outer surfaces of any one of the two electrodes. The ceramic coating layer may function as a separator membrane such that the separator membrane made from polymers such as polypropylene (PP) or polyethylene (PE) may be omitted.

The material of the ceramic powder is selected from one or more of boehmite, alumina, silica, zirconia, zeolite, magnesia, titanium oxide and barium titanate. Decomposition temperatures of these materials are higher than 1,000° C. Thus, thermal stability of the lithium-ion battery formed by using the ceramic coating layer is prominently improved. The boehmite material has a plate-like crystal structure, excellent thermal conductivity and excellent flame retardancy. As a preferred, non-limiting example, the ceramic powder is boehmite powder.

The electrolyte may be an organic electrolyte solution. The organic electrolyte solution is prepared by dissolving a lithium salt in an organic solvent. The organic solvent may be any suitable material that can be used as an organic solvent. Examples of the organic solvent are propylenecarbonate, ethylenecarbonate, fluoroethylenecarbonate, butylenecarbonate, dimethylcarbonate, diethylcarbonate, methylethylcarbonate, methylpropylcarbonate, ethylpropylcarbonate, methylisopropylcarbonate, dipropylcarbonate, dibutylcarbonate, benzonitrile, acetonitrile, tetrahydrofuran, 2-methyltetrahydrofuran, γ-butyrolactone, dioxolane, 4-methyldioxolane, N,N-dimethylformamide, dimethylacetamide, dimethylsulfoxide, dioxane, 1,2-dimethoxyethane, sulfolane, dichloroethane, chlorobenzene, nitrobenzene, diethyleneglycol, dimethylether, and any combination thereof. The lithium salt may be any one of various lithium salts used in the art. For examples, the lithium salt includes LiPF₆, LiBF₄, LiSbF₆, LiAsF₆, LiClO₄, LiCF₃SO₃, Li(CF₃SO₂)₂N, LiCAF₉SO₃, LiAlO₂, LiAlCl₄, LiN(CₓF₂ₓ+1SO₂) (C_{y}F_{2y}+1SO₂) (each of x and y is a natural number), LiCl, LiI, and a mixture thereof.

In addition to the above-mentioned organic electrolytes, additional exemplary electrolytes further include non-aqueous electrolytes, organic solid electrolytes, inorganic solid electrolytes, and the like. Examples of an organic solid electrolyte includes a polyethylene derivative, a polyethylene oxide derivative, a polypropylene oxide derivative, an ester phosphate polymer, polyester sulfide, polyvinyl alcohol, PVDF, a polymer including an ionic dissociation group, etc. Examples of an inorganic solid electrolyte are nitride solid electrolytes, oxynitride solid electrolytes, and sulfide solid electrolytes. Examples of an inorganic solid electrolyte include Li₃N, LiI, Li₅NI₂, Li₃N—LiI—LiOH, Li₂SiS₃, Li₄SiO₄, Li₄SiO₄—LiI—LiOH and Li₃PO₄—Li₂S—SiS₂.

The binder is used to prevent separation of ceramic powder. Non-limiting examples of the binder include PVDF, CMC, SBR, polybenzimidazole, polyimide, polyvinylacetate, polyacrylonitrile, polyvinylalcohol, starch, hydroxypropyl methyl cellulose, regenerated cellulose, polyvinylpyrrolidone, polyethylene, polymethylmethacrylate, polyaniline, polypropylene, polystyrene, acrylonitrile-butadiene-styrene, phenol resin, epoxy resin, polyethylene terephthalate, polytetrafluoroethylene, polyphenylsulfide, polyamideimide, polyetherimide, polyethylenesulfone, polyacetal, polyphenyleneoxide, polybutylene terephthalate, EPDM, sulfonated EPDM, fluoride rubber and various copolymers. Preferably, the binder is selected from one or more of PVDF, CMC and SBR. As a preferred, non-limiting example, the binder is PVDF. Typically, the binder may burn when the temperature of the lithium-ion battery is increased over the decomposition temperature of the binder by generation of an internal short. Since the ceramic powder is an inorganic metal oxide and has heat resistance to temperatures higher than 1,000° C., it is desirable that the amount of ceramic powder is as much as possible, and the binder is used in an amount that maintains a minimum adhesive force. An optimum weight ratio of the ceramic powder to the binder may vary according to kinds of the ceramic powder and binder. Preferably, the mass ratio of the ceramic powder to the binder in the ceramic coating is (80-95):(5-20), preferably (80-90):(10-20), more preferably 85:15.

To improve thermal stability of the lithium-ion battery as described above, it is desirable that the ceramic powder should be uniformly coated without defects. In other words, it is desirable that the ceramic powder be coated to a uniform thickness on the electrode surface without defects such as uncoated parts, pin holes and cracks. Through a large number of experiments, the present invention has found that the defects above can be overcome by controlling factors such as the roughness Ra of the surfaces of the electrode, the thickness of the ceramic coating, and the particle size of the ceramic powder, thereby obtaining a ceramic coating that can replace the separator membrane.

As a non-limiting example, the thickness of the ceramic coating is 6 μm-9 μm, preferably 7 μm-9 μm, more preferably 8 μm-9 μm; and the particle size of the ceramic powder has a D₅₀ of 0.05 μm-0.6 μm, preferably 0.07 μm-0.4 μm, more preferably 0.09 μm. In addition, the roughness Ra of the electrode surface also has a certain influence on the coating effect of the ceramic powder. To meet the coating requirements, as a non-limiting example, the roughness Ra needs to be controlled within a certain range, for example, 0.4 μm-1.6 μm, preferably 0.6 μm-1.4 μm, more preferably 0.8 μm-1.2 μm.

In addition, in order to improve the properties of the ceramic coating, such as insulating properties, thermal conductivity, and flame retardant properties, the ceramic coating may further include an additive. As a non-limiting example, the additive is selected from one or two of PE and PP.

In order to coat the ceramic powder to a uniform thickness on the electrode active material without defects such as uncoated parts, pin holes and cracks, the present invention provides a method for producing an electrode ceramic coating, comprising
step 1, determining the roughness Ra of an electrode surface, and if Ra meets a given coating requirement, proceeding to step 2, if not, performing a pretreatment to the electrode surface to make Ra meet the given coating requirement;
step 2, coating a ceramic slurry on the electrode surface with the roughness Ra meeting the given coating requirement to form a coating layer; and
step 3, drying the coating layer to obtain a coating.

The roughness of the electrode surface is determined by the surface of electrode material or current collector (uncoated with electrode material). If the electrode material is small in the particle size and distributed uniformly or the surface of the current collector (uncoated with electrode material) is relatively smooth, the roughness Ra of the electrode surface is small. If the roughness Ra meets a given coating requirement, the ceramic slurry can be directly coated on the electrode surface to form a coating layer. If the roughness Ra of the electrode surface does not meet the given coating requirement, the electrode surface needs to be pretreated. As a non-limiting example, the method for pretreatment is calendaring the electrode until the roughness Ra meets the given coating requirement.

The ceramic slurry in step 2 includes a ceramic powder, a binder, and a solvent. The solvent forming the ceramic slurry may include one or more selected from NMP, cyclohexanone, water, toluene and xylene. The solvent is totally evaporated in the drying process after the solvent functions as a dispersing medium for helping to disperse the ceramic powder and binder. Thus, the ceramic powder and binder forms the ceramic coating layer.

As a non-limiting example, the solid content of the ceramic slurry is 20%-30%, and the mass ratio of the ceramic powder to the binder is (80-95):(5-20), preferably (80-90):(10-20), more preferably 85:15.

The method for coating the ceramic slurry in step 2 is a common coating method, including spraying, printing, extruding or transferring, etc.

In order to test the performance of the ceramic coating and compare with that of the traditional separator membrane, tests such as Hi-pot test, EIS test, charge and discharge test, cycle life test and heating test are used in the present invention. Such tests are all conventional testing and characterization methods in the art, and the operation processes will not be described in detail herein.

As described above, in the electrode ceramic coating and the lithium-ion battery with the electrode ceramic coating, by controlling the roughness of the electrode surface, the thickness of the ceramic coating, and the particle size distribution of the ceramic powder, the ceramic powder can be coated to a uniform coating on the electrode without defects such as pin holes and cracks. Such a coating can replace the traditional separator membrane, so that the lithium-ion battery can be used normally without the separator membrane. Accordingly, generation of an internal short is prevented by preventing current from being concentrated at defective portions. Thus, thermal decomposition of the active material and electrolyte and combustion or explosion of the lithium-ion battery can be prevented further. The cycle life of lithium-ion batteries can be effectively improved. In addition, the ceramic coating is applied with uniform thickness. Thus, the electrodes are precisely formed in desired size when the electrodes are wound in a jelly-roll type.

### DETAILED DESCRIPTION OF THE EMBODIMENTS

The following examples describe several embodiments of the invention, which are illustrative and not intended to limit the present invention in any way.

The method for producing the electrode ceramic coating used in the following examples comprises the following steps:
step 1, coating a ceramic slurry on the electrode surface to completely cover the electrode active material (such as NCM or graphite), so as to form a coating layer; and
step 2, drying the coating layer at 70° C. to 90° C. to obtain the ceramic coating.

The ceramic slurry is prepared by the following steps:
step 1.1, adding the binder (such as PVDF) into the solvent (such as NMP) and stirring at 500 rpm to 700 rpm for 1.5 h to 2.5 h until the binder is completely dissolved in the solvent to obtain a uniform colloidal liquid; and
step 1.2, adding the ceramic powder (such as boehmite) into the colloidal liquid obtained in step 1.1 and stirring at 500 rpm to 700 rpm for 1.5 h to 2.5 h to obtain a uniform ceramic slurry.

Among them, by controlling the addition amounts of the ceramic powder, the binder and the solvent, different mass percentages of the solid contents and different mass ratios of the ceramic powder to the binder in the ceramic coating can be obtained.

Among them, Kejing MSK-2150 calender is used during the calendaring, Kejing MSK-SFM-16 vacuum mixer is used during the stirring, and Kejing MSK-AFA-ES200 coating machine is used during the coating.

### Example 1. Effects of Electrode Surface Roughness and Coating Thickness on Properties of Ceramic Coating

### (1) Surface Roughness Measurement and Hi-Pot Test

Electrodes: the collector is in the form of aluminum foil; the active material is NCM; the thickness of the pristine electrode is 140 μm; and the electrode surface is not smooth.

The above electrodes were pre-calendered and calendered, and the surface roughnesses were measured. The results are shown in the table below.

| | Pristine | Pre-calendered | Calendered |
|---|---|---|---|
| | electrode | electrode | electrode |
| Thickness, μm | 140 | 130 | 104 |
| Press density, g/cc | 2.36 | 2.57 | 3.29 |
| Surface roughness Ra, | 1.662 | 1.038 | 0.398 |
| μm | | | |

After pre-calendaring pristine electrode from 140 μm to 130 μm, the electrode surface was smooth, and the surface roughness Ra was 1.038 μm. The electrode surface was coated with 27% solid content (the mass ratio of boehmite to PVDF was 85:15, and D₅₀ of boehmite was 0.09 μm) of ceramic slurry to form a coating layer. The coating layer was dried to obtain a ceramic coating. It was found that the electrode with the coating thickness of 8 μm passed Hi-pot test, while the electrode with the coating thickness of 5 μm failed. For the Hi-pot test, cathode plate with the ceramic coating and anode plate without the ceramic coating or anode plate with the ceramic coating and cathode plate without the ceramic coating were assembled, and a test voltage of 250 V was applied to test the insulation of the ceramic coating.

After calendaring the pristine electrode from 140 μm to 104 μm, some wrinkles appeared on the electrode surface, and the surface roughness Ra was 0.398 μm. The electrode surface was coated with 27% solid content (the mass ratio of boehmite to PVDF was 85:15, and D₅₀ of boehmite was 0.09 μm) of ceramic slurry to form a coating layer. The coating layer was dried to obtain a coating. The thickness of the obtained coating was uneven.

### (2) EIS Test

Further, the pristine electrode (with the surface roughness Ra of 1.662 μm), the pre-calendered electrode (with the surface roughness Ra of 1.038 μm) and the traditional separator membrane (PE) electrode were subjected to EIS Test (5 mV, 0.1-100K Hz). The diffusion resistance, diffusion resistivity and capacitance of symmetric cells were obtained and the results were shown in the table below.

| | Pristine | Pre-calendered | Separator |
|---|---|---|---|
| | electrode | electrode | membrane |
| Coating thickness, μm | 8 | 8 | / |
| Single-side electrode | 56 | 57 | 48 |
| thickness, μm | | | |
| Diffusion resistance, Ω*cm² | 4.47 | 3.30 | 3.66 |
| Diffusion resistivity, Ω · cm | 798.2 | 578 | 762 |
| Capacitance, mF*cm² | 23.5 | 24 | 24 |

After coating, the diffusion resistance and the diffusion resistivity of the pre-calendered electrode was much lower than those of the pristine electrode and the traditional separator membrane electrode.

### Example 2. Effects of Ceramic Materials and Particle Size Distribution on Properties of Ceramic Coating

### (1) Hi-Pot Test

Electrodes: the collector is in the form of aluminum foil; the active material is NCM; the pre-calendered electrode has the thickness of 130 μm (2.57 g/cc) and the surface roughness Ra of 1.038 μm; and the calendered electrode has the thickness of 104 μm (3.29 g/cc) and the surface roughness Ra of 0.398 μm.

Ceramic coating: the ceramic material is boehmite, and the particle size distribution D₅₀ of the ceramic powder is 0.09 μm, 0.4 μm, 0.09 μm+2 μm (D₅₀ of 0.09 μm plus D₅₀ of 2 μm, each accounting for 50%), and 2 μm respectively; or the ceramic material is alumina, and the particle size distribution D₅₀ of the ceramic powder is 0.3 μm. The electrode surfaces above were coated with 27% solid content (the mass ratio of ceramic material to PVDF was 85:15) of ceramic slurry to form a coating layer, and the coating layer was dried to obtain a coating. The coating was subjected to Hi-pot test and the results were shown in the table below.

| | | Pre- | Pre- | |
|---|---|---|---|---|
| | | calendered | calendered | Calendered |
| | | electrode | electrode | electrode |
| | Particle size | Coating | Coating | Coating |
| Ceramic | distribution | thickness, | thickness, | thickness, |
| material | D₅₀, μm | 5 μm | 8 μm | 8 μm |
| Boehmite | 0.09 | NG | Pass | Delamination |
| | | | | occurs |
| Boehmite | 0.4 | NG | Pass | Pass |
| Boehmite | 0.09 + 2 | NG | Pass | Pass |
| Boehmite | 2 | NG | Pass | Pass |
| Alumina | 0.3 | NG | Pass | Pass |

It was found that the electrode with the coating thickness of 8 μm passed the Hi-pot test, while the electrode with the coating thickness of 5 μm failed. The boehmite ceramic coating electrode with D₅₀ of 0.09 μm showed partial delamination between the calendaring electrode and the coating.

### (2) EIS Test

Further, the diffusion resistance, diffusion resistivity and capacitance of symmetric cells were obtained by EIS Test (5 mV, 0.1-100 K Hz) for different particle size distributions of ceramic powder, compared with the conventional separator membrane (PE) electrolyte. The results were shown in the table below.

| Ceramic material | Boehmite | Boehmite | Boehmite | Boehmite | Alumina | Separator membrane |
|---|---|---|---|---|---|---|
| Particle size | 0.09 | 0.4 | 0.09 + 2 | 2 | 0.3 | / |
| distribution D₅₀, | | | | | | |
| μm | | | | | | |
| Coating | 8 | 8 | 9 | 8 | 9 | / |
| thickness, | | | | | | |
| μm | | | | | | |
| Single-side | 57 | 56 | 56 | 57 | 56 | 48 |
| electrode | | | | | | |
| thickness, | | | | | | |
| μm | | | | | | |
| Diffusion | 3.30 | 4.62 | 4.89 | 4.86 | 4.29 | 3.66 |
| resistance, | | | | | | |
| Ω*cm² | | | | | | |
| Diffusion | 578 | 825 | 873 | 852 | 766.1 | 762 |
| resistivity, | | | | | | |
| Ω · cm | | | | | | |
| Capacitance, | 24 | 21.4 | 24 | 23.4 | 21.3 | 24 |
| mF*cm² | | | | | | |

Unexpectedly, it was found that the diffusion resistance and the diffusion resistivity of the boehmite ceramic coating electrode with D₅₀ of 0.09 μm were much smaller than those of the boehmite/alumina ceramic coating electrodes with other particle size distribution, and even much smaller than that of the traditional separator membrane electrode.

### (3) Pore Volume Test

By comparing the pore volumes of ceramic coating electrodes with different particle size distributions and pristine electrode, the results were shown in the table below.

| Ceramic material | Boehmite | Boehmite | Boehmite | Boehmite | Alumina | Pristine electrode |
|---|---|---|---|---|---|---|
| Particle size | 0.09 | 0.4 | 0.09 + 2 | 2 | 0.3 | / |
| distribution D₅₀, | | | | | | |
| μm | | | | | | |
| Mass loading, | 30.27 | 30.27 | 30.27 | 30.27 | 30.27 | 30.27 |
| mg/cm² | | | | | | |
| Electrode | 116 | 115 | 115 | 116 | 116 | 106 |
| thickness, | | | | | | |
| μm | | | | | | |
| Ceramic coating | 8 | 8 | 9 | 8 | 9 | / |
| thickness, | | | | | | |
| μm | | | | | | |
| Press density, | 3.40 | 3.40 | 3.40 | 3.40 | 3.40 | 3.40 |
| g/cc | | | | | | |
| Measured | 3.15 | 3.19 | 3.22 | 3.15 | 3.19 | 3.22 |
| density, | | | | | | |
| g/cc | | | | | | |
| Pore volume, | 104.7 | 103.0 | 91.4 | 97.9 | 109.4 | 101.8 |
| uL/g | | | | | | |
| 3 nm-10 μm | | | | | | |
| Pore volume, | 315.7 | 289.3 | 274.3 | 259.8 | 309.4 | 285.7 |
| uL/mL | | | | | | |
| 3 nm-10 μm | | | | | | |

The pore volume (uL/mL) of the boehmite ceramic coating electrode with D₅₀ of 0.09 μm is much higher than those of other ceramic coating electrodes and pristine electrode.

### Example 3. Effect of Ceramic Coating Composition on Properties of Ceramic Coating

Electrodes: the collector is in the form of aluminum foil; the active material is NCM; the pristine electrode has the thickness of 140 μm (2.36 g/cc) and the surface roughness Ra of 1.662 μm; and the pre-calendered electrode has the thickness of 130 μm (2.57 g/cc) and the surface roughness Ra of 1.038 μm.

### (1) Effect of Solid Content in Ceramic Slurry on Properties of Ceramic Coating

The electrode surfaces above were coated with ceramic slurry having different solid contents (the mass ratio of boehmite to PVDF was 85:15, and D₅₀ of boehmite powder was 0.09 μm) to form coating layers. The coating layers were dried to obtain coatings having the thicknesses of 8 μm. The coatings were subjected to Hi-pot test and the results were shown in the table below.

| | | | | | |
|---|---|---|---|---|---|
| Solid content, % | 15 | 20 | 27 | 30 | 35 |
| Viscosity, Cp | 382 | 1830 | 18600 | 87240 | 181900 |
| Pristine electrode | NG | Pass | Pass | Pass | Pass |
| Pre-calendered | NG | Pass | Pass | Pass | Pass |
| electrode | | | | | |

It was found that the electrode with 15% solid content cannot pass Hi-pot test. When the solid content was up to 35%, the ceramic slurry had a relatively high viscosity and was difficult to be coated on the electrode.

### (2) Effect of Mass Ratio of Ceramic Powder to Binder on Properties of Ceramic Coating

The electrode surfaces above were coated with ceramic slurry having 27% solid content (the mass ratio of boehmite to PVDF was shown in the table below, and D₅₀ of ceramic powder is 0.09 μm) to form coating layers, the coating layers were dried to obtain coatings having the thicknesses of 8 μm. The coatings were subjected to Hi-pot test and the results were shown in the table below.

| | | | | | |
|---|---|---|---|---|---|
| Boehmite:PVDF | 97:3 | 90:10 | 85:15 | 80:20 | 75:25 |
| Viscosity, Cp | 928 | 6790 | 18600 | 40380 | 107000 |
| Pristine electrode | NG | Pass | Pass | Pass | Pass |
| Pre-calendered | NG | Pass | Pass | Pass | Pass |
| electrode | | | | | |

It was found that when the mass ratio of boehmite to PVDF was 97:3, the electrode content cannot pass Hi-pot test. When the mass ratio of boehmite to PVDF was 75:25, the ceramic slurry had a relatively high viscosity and was difficult to be coated on the electrode.

### Example 4. Improvement of contact angle of electrode surface by the Ceramic Coating

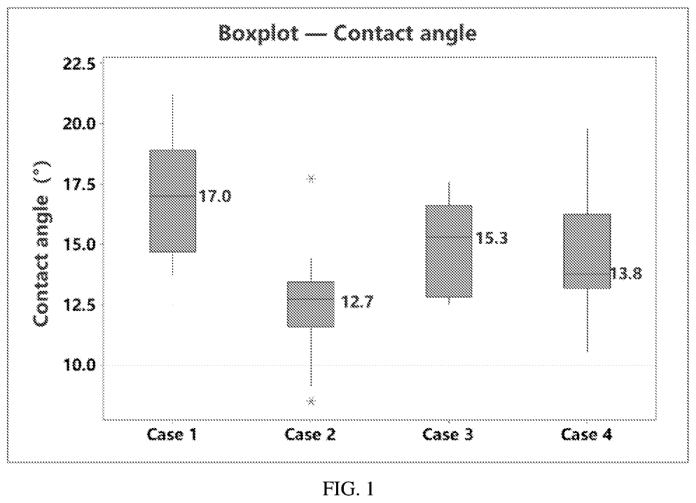

The contact angles of the electrode surfaces were measured for the different electrodes shown in the table below, and the results are shown in FIG. 1.

| | | |
|---|---|---|
| Case 1 | Pristine electrode | The collector is copper foil, the active |
| | | material is graphite, and the electrode |
| | | thickness is 142 μm. |
| Case 2 | Pristine electrode | The collector is copper foil, the active |
| | with ceramic | material is graphite, the electrode thickness |
| | coating | is 142 μm, the ceramic material is boehmite, |
| | | and the thickness of the ceramic coating is |
| | | 8 μm. |
| Case 3 | Pre-calendered | The collector is copper foil, the active |
| | electrode | material is graphite, and the electrode |
| | | thickness is 130 μm (1.06 g/cc) |
| Case 4 | Pre-calendered | The collector is copper foil, the active |
| | electrode with | material is graphite, the electrode thickness |
| | ceramic coating | is 130 μm (1.06 g/cc), the ceramic material |
| | | is boehmite, and the thickness of the ceramic |
| | | coating is 8 μm. |

As shown in FIG. 1, the contact angles of the electrode surfaces with a ceramic coating were smaller than those without a ceramic coating, thus the electrode with a ceramic coating would have a better infiltration with the electrolyte.

### Example 5. Comparison of Properties of Ceramic Coating and Traditional Separator Membrane

### (1) Charge/Discharge Test

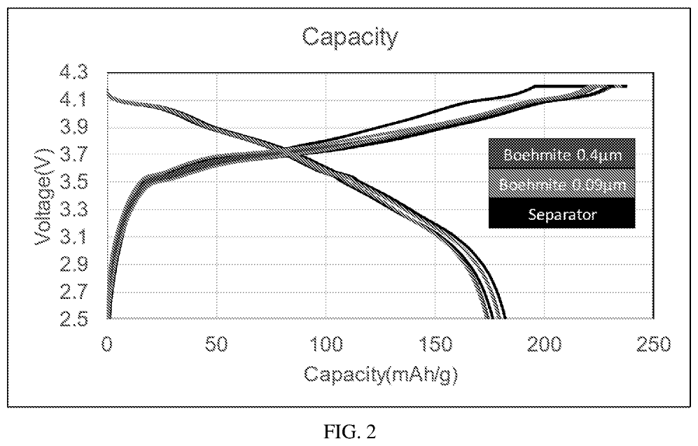

Charge and discharge parameters of full cell were obtained through a charge and discharge test (current: +0.1C/-0.1C, voltage: 4.2-2.5 V) by comparing the full cell with a ceramic coating (boehmite ceramic material, with D₅₀ of 0.09 μm/0.4 μm and coating thickness of 8 μm) and without a separator membrane (for cathode, the collector was aluminum foil and the active material was NCM; for anode, the collector was copper foil and the active material was graphite), with the full cell with a separator membrane (PE). The results were shown in the table below, and the charge-discharge curves were shown in FIG. 2.

| | Boehmite | Boehmite | |
|---|---|---|---|
| | D₅₀ of | D₅₀ of | Separator |
| | 0.09 μm | 0.4 μm | membrane |
| Coating thickness, μm | 8 | 8 | / |
| Charge capacity, mAh | 0.03256 | 0.03342 | 0.03384 |
| Discharge capacity, mAh | 0.02543 | 0.02552 | 0.02586 |
| Normalized charge capacity, | 225.98 ± 2 | 231.99 ± 2 | 234.93 ± 2 |
| mAh/g | | | |
| Normalized discharge | 176.51 ± 3 | 177.18 | 179.52 |
| capacity, mAh/g | | | |
| First Efficiency (%) | 78.10% | 76.41% | 76.44% |

It can be seen that the charge-discharge curves of the boehmite ceramic coating electrode and the separator membrane electrode were basically the same, and the first efficiency of the boehmite ceramic coating electrode with D₅₀ of 0.09 μm was slightly higher than those of the boehmite ceramic coating electrode with D₅₀ of 0.4 μm and the separator membrane electrode.

### (2) Cycle Life Test

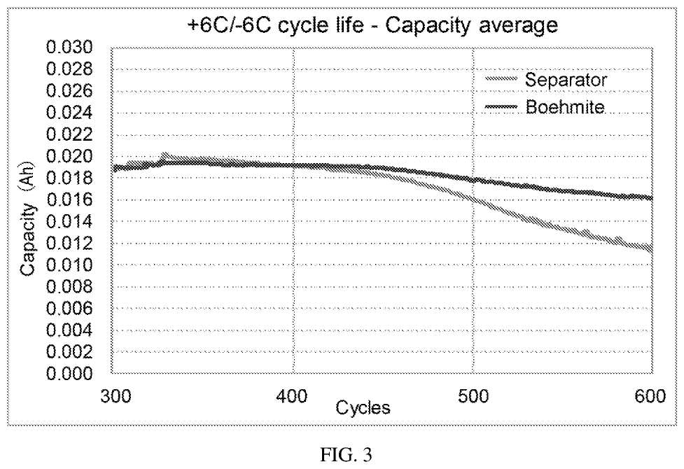

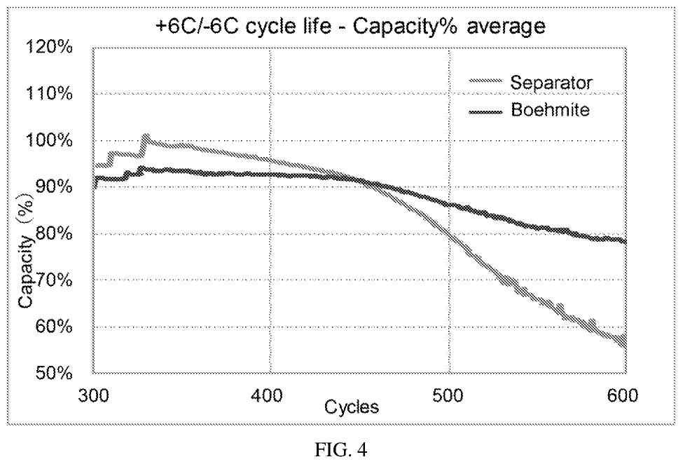

The cycle life curves of full cell were obtained through cycle life test (charge: 6C CC to 4.2V, CV to 0.15C, rest: 10 min; discharge: 6C DC to 2.5V; rest: 10 min) by comparing the full cell with a ceramic coating (boehmite ceramic material, with D₅₀ of 0.09 μm and coating thickness of 8 μm) and without a separator membrane (for cathode, the collector was aluminum foil and the active material was NCM; for anode, the collector was copper foil and the active material was graphite), with the full cell with a separator membrane (PE). The results were shown in FIGS. 3 and 4.

Unexpectedly, it was found that the average capacity (Ah) of the conventional separator membrane electrode began to decrease rapidly when the number of cycles was ≥400, while the average capacity of the boehmite coating electrode decreased slowly and was higher than the conventional separator membrane electrode, with an increasing gap as the number of cycles was increased (FIG. 3). The average capacity % of the conventional separator membrane electrode began to decrease rapidly with the increase of the number of cycles, while the average capacity % of the boehmite coating electrode began to decrease slowly when the number of cycles was ≥450 and was higher than the conventional separator membrane electrode, with an increasing gap as the number of cycles was increased (FIG. 4).

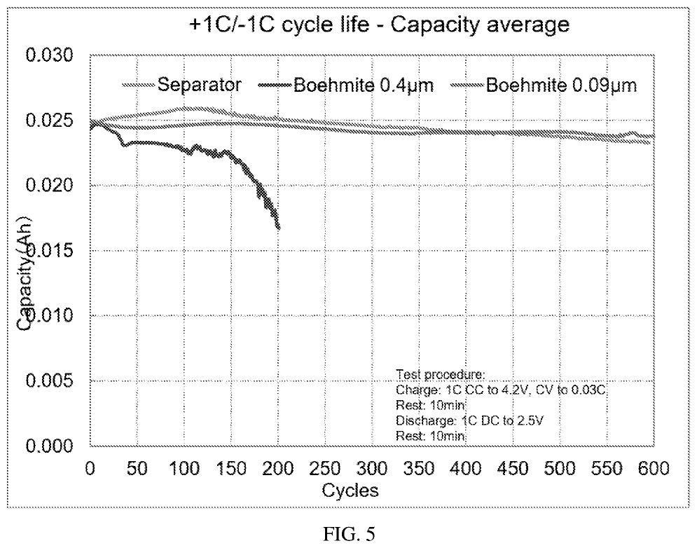

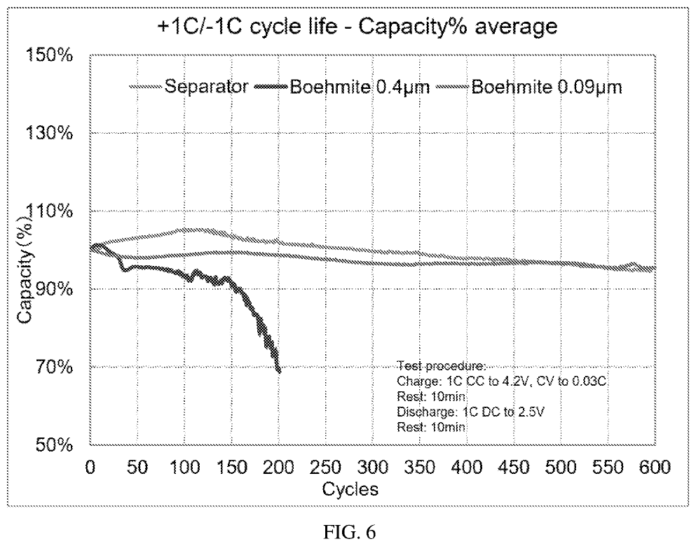

Further, the cycle life curves of full cell were obtained through cycle life test (charge: 1C CC to 4.2V, CV to 0.02C, rest: 10 min; discharge: 1C DC to 2.5V; rest: 10 min) by comparing the full cell with a ceramic coating (boehmite ceramic material, with D₅₀ of 0.09 μm or 0.4 μm and coating thickness of 8 μm) and without a separator membrane (for cathode, the collector was aluminum foil and the active material was NCM; for anode, the collector was copper foil and the active material was graphite), with the full cell with a separator membrane (PE). The results were shown in FIGS. 5 and 6.

Unexpectedly, it was found that when the number of cycles≥100, the average capacity (Ah) and the average capacity % of the ceramic coating having D₅₀ of 0.4 μm decline rapidly, the average capacity (Ah) and the average capacity % of the conventional separator membrane electrode began to decline slowly, while the average capacity (Ah) and the average capacity % of the ceramic coating having D₅₀ of 0.09 μm remain basically stable; when the number of cycles≥425, the average capacity (Ah) of the boehmite coating electrode was higher than the conventional separator membrane electrode, with an increasing gap as the number of cycles was increased (FIG. 5); and when the number of cycles≥500, the average capacity (%) of the boehmite coating electrode was higher than the conventional separator membrane electrode, with an increasing gap as the number of cycles was increased (FIG. 6).

### (3) Heating Test

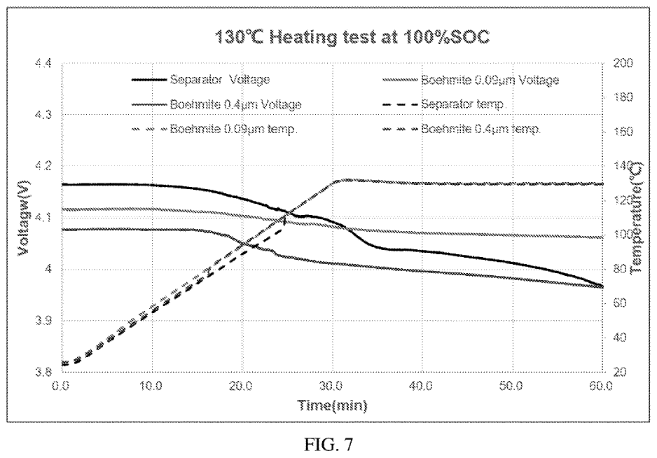

The heating test curves of full cell were obtained through a heating test (130° C., 100% SOC) by comparing the full cell with a ceramic coating (boehmite ceramic material, with D₅₀ of 0.09 μm/0.4 μm and coating thickness of 8 μm) and without a separator membrane (for cathode, the collector was aluminum foil and the active material was NCM; for anode, the collector was copper foil and the active material was graphite), with the full cell with a separator membrane (PE). The results were shown in FIG. 7.

Unexpectedly, it was found that the switch voltage of the ceramic coating electrode was relatively low. After heating at 130° C., the voltage of the conventional separator membrane electrode began to drop rapidly, while the voltage of the boehmite coating electrode with D₅₀ of 0.09 μm remained stable and higher than that of the conventional separator membrane electrode, indicating that the boehmite coating electrode had a better thermal stability.

### Example 6. Production of Separator Membrane-Free Battery

The method for producing a separator membrane-free battery comprises the following steps:
step 1, pre-calendaring the prepared electrode plate so that the surface roughness Ra of the electrode plate is 0.8-1.2 μm;
step 2, adding the binder PVDF into the solvent NMP and stirring at 600 rpm for 2 h until PVDF is completely dissolved in NMP to obtain a uniform colloidal liquid;
step 3, adding the ceramic powder into the colloidal liquid obtained in step 2 and stirring at 600 rpm for 2 h to obtain a uniform ceramic slurry;
step 4, uniformly coating the prepared ceramic slurry on the surface of the electrode plate calendered in step 1 to completely cover the active material thereon, then drying at 80° C. to obtain a ceramic coating, wherein the thickness of the ceramic coating is controlled to be 6 μm to 9 μm, preferably 7 μm to 9 μm, more preferably 8 μm to 9 μm;
step 5, calendaring the electrode plate with the ceramic coating obtained in step 4 until the active material thereon reaches the target press density (3.4 g/cc for NCM, and 1.4 g/cc for graphite); and
step 6, assembling the electrode plate with the ceramic coating obtained in
step 4, and filling with electrolyte to obtain the battery.

1. An electrode ceramic coating comprising a ceramic powder and a binder, wherein the thickness of the ceramic coating is 6 μm-9 μm, preferably 7 μm-9 μm, more preferably 8 μm-9 μm.

2. The electrode ceramic coating of claim 1, wherein the material of the ceramic powder is selected from one or more of boehmite, alumina, silica, zirconia, zeolite, magnesia, titanium oxide and barium titanate, preferably boehmite and alumina, more preferably boehmite.

3. The electrode ceramic coating of claim 1, wherein the binder is selected from one or more of PVDF, CMC and SBR, preferably PVDF.

4. The electrode ceramic coating of claim 1, wherein the mass ratio of the ceramic powder to the binder in the ceramic coating is (80-95):(5-20), preferably (80-90):(10-20), more preferably 85:15.

5. The electrode ceramic coating of claim 1, wherein the pore volume of the ceramic coating is 280 uL/mL-320 uL/mL, preferably 289 uL/mL-316 uL/mL, more preferably 315.7 uL/mL.

6. The electrode ceramic coating of claim 1, wherein the ceramic coating further comprises an additive, wherein the additive is selected from one or two of PE and PP.

7. The electrode ceramic coating of claim 1, wherein the ceramic coating is obtained by coating a ceramic slurry on the electrode surface to form a coating layer, and drying the coating layer.

8. A lithium-ion battery, comprising a cathode electrode, an anode electrode, electrolyte and a housing, wherein the cathode electrode includes a cathode collector and a cathode active material coated thereon, the anode electrode includes an anode collector and an anode active material coated thereon, and wherein the cathode electrode and the anode electrode face each other, and at least one of surfaces of the cathode electrode and the anode electrode that face each other has the electrode ceramic coating of claim 1.

9. The lithium-ion battery of claim 8, wherein the cathode active material is selected from one or more of lithium nickel cobalt manganate (NCM), lithium cobaltate, lithium nickelate, lithium manganate (LMO), lithium nickel cobalt aluminate, and lithium iron phosphate, preferably lithium nickel cobalt manganate (NCM), and wherein the cathode collector is aluminum foil.

10. The lithium-ion battery of claim 8, wherein the anode active material is selected from one or more of graphite (C), soft carbon, hard carbon, silicon-carbon composite, elemental silicon and SiOₓ, preferably graphite (C), and wherein the anode collector is copper foil.

11. The lithium-ion battery of claim 8, wherein the cathode electrode and/or the anode electrode further include a conductive agent, and the conductive agent can be selected from one or more of conductive carbon black, superconductive carbon black (SP), conductive carbon nanotube, conductive fiber and graphite, preferably conductive carbon black, more preferably superconductive carbon black (SP).

12. The lithium-ion battery of claim 8, wherein the electrolyte is an organic electrolyte, non-aqueous electrolyte, organic solid electrolyte or inorganic solid electrolyte.

13. The lithium-ion battery of claim 8, wherein the lithium-ion battery does not comprise a separator membrane.

14. The lithium-ion battery of any one of claim 8, wherein the lithium-ion battery does not comprise a tab.

15. The lithium-ion battery of claim 8, wherein the cathode active material has a press density of 2.5 g/cc-4.0 g/cc, preferably 3.0 g/cc-3.5 g/cc, more preferably 3.4 g/cc.

16. The lithium-ion battery of claim 8, wherein the anode active material has a press density of 0.5 g/cc-2.0 g/cc, preferably 1.0 g/cc-1.5 g/cc, more preferably 1.4 g/cc.

17. Use of the electrode ceramic coating of claim 1 for extending the cycle life of a lithium-ion battery.

18. Use of the electrode ceramic coating of claim 1 for reducing the average capacity (Ah) degradation of a lithium-ion battery after multiple cycles.

19. Use of the electrode ceramic coating of claim 1 for retaining the average capacity efficiency (%) of a lithium-ion battery after multiple cycles.

20. Use of claim 17, wherein the number of cycles of the lithium-ion battery is ≥400, preferably ≥500, more preferably ≥600.

21. Use of claim 19, wherein when the number of cycles of the lithium-ion battery is ≥400, preferably ≥500, more preferably ≥600, the average capacity efficiency (%) retains≥ 70%, preferably ≥75%, more preferably ≥80%.

22. Use of the electrode ceramic coating of claim 1 for improving the thermal stability of a lithium-ion battery under a high temperature.

23. Use of claim 22, wherein the high temperature is 130° C. or higher.

24. Use of the electrode ceramic coating of claim 1 for reducing the contact angle of an electrode surface of a lithium-ion battery.
